(19) United States
(12) Patent Application Publication
(10) Pub. No.: US 2014/0156853 A1
(43) Pub. Date: Jun. 5, 2014

(54) COMPUTER AND RESOURCE RETRIEVAL METHOD

(71) Applicants: Shinichiro Suda, Tokyo (JP); Akihisa Ushirokawa, Tokyo (JP); Yohei Hayashi, Tokyo (JP)

(72) Inventors: Shinichiro Suda, Tokyo (JP); Akihisa Ushirokawa, Tokyo (JP); Yohei Hayashi, Tokyo (JP)

(73) Assignee: NEC CORPORATION, Tokyo (JP)

(21) Appl. No.: 14/233,523

(22) PCT Filed: Jul. 12, 2012
(86) PCT No.: PCT/JP2012/004495

§ 371 Date: Jan. 17, 2014

(30) Foreign Application Priority Data
Aug. 4, 2011 (JP) 2011-170768

(51) Int. Cl. H04L 12/911

(52) U.S. Cl. CPC H04L 47/78
USPC 709/226

(57) ABSTRACT

The computer is connected with a plurality of computer systems each having one or more resources. The computer stores information relating to a network connecting a first computer system, which is a particular computer system of the plurality of the computer systems, and second computer systems which are those other than the particular computer system. The computer computes a set of the second computer systems connected with the first computer system over the network based on the information relating to the network, and retrieves a resource to be provided for use in the first computer system from among the resources held by the second computer systems included in the computed set.

### TECHNICAL FIELD

The present invention relates to a computer which retrieves computer resources such as servers and storages and network resources, required by a computer system, from other computer systems.

### BACKGROUND ART

Computer resources such as servers and storages and network resources, required for executing programs in computer systems, are called resources. A computer system manages the usage of the resources in the own system, and when the load increases or a failure occurs in any of the resources, the computer system secures a resource to be used from among the unused resources in the own system. However, in recent years, in order to cope with resource shortage, accommodation of resources between computer systems has been proposed and put into practical use.

Patent Document 1 discloses an example of this type of art. The art disclosed in Patent Document 1 is intended for clusters as computer systems, and retrieves a resource satisfying the conditions required by a first cluster, of a group of clusters communicable with one another over networks, from among resources of other clusters.

Patent Document 1: JP 2006-23948 A

### SUMMARY

Patent Document 1 is based on an assumption that a computer system, which is a borrower of a resource, is communicable with all other computer systems which are lenders of resources. As such, under a circumstance where there is a computer system not connected with a computer system which is a borrower of a resource in the other computer systems, even if retrieval of a resource succeeds, actual accommodation of the resource fails, because in order to use a resource of other computer systems as a resource of a borrower computer system, it is necessary that the borrower computer system and the other computer system are communicable with each other.

An object of the present invention is to provide a computer which solves the above-described problem, that is, a problem that a resource which cannot be accommodated in practice may be retrieved.

A computer, according to an aspect of the present invention, is a computer connected with a plurality of computer systems each having one or more resources, the resources being a computer resource and a network resource. The computer is configured to include

a network information storage means for storing information relating to a network connecting a first computer system and second computer systems, the first computer system being a particular computer system of the plurality of the computer systems, the second computer systems being computer systems other than the particular computer system; and

a retrieval means for computing a set of the second computer systems connected with the first computer system over the network based on the information relating to the network stored in the network information storage means, and retrieving a resource to be provided for use in the first computer system, from among resources held by the second computer systems included in the computed set.

Further, a resource retrieval method, according to another aspect of the present invention, is a method to be executed by a computer connected with a plurality of computer systems each having one or more resources, the resources being a computer resource and a network resource, the computer including network information storage means for storing information relating to a network connecting a first computer system and second computer systems, the first computer system being a particular computer system of the plurality of the computer systems, the second computer systems being computer systems other than the particular computer system. The method is configured to include

computing a set of the second computer systems connected with the first computer system over the network based on the information relating to the network stored in the network information storage means; and

retrieving a resource to be provided for use in the first computer system, from among resources held by the second computer systems included in the computed set.

With the above-described configuration, the present invention is able to prevent a case where a resource which cannot be accommodated in practice is retrieved.

### BRIEF DESCRIPTION OF DRAWINGS

FIG. 1 is a block diagram showing a first exemplary embodiment of the present invention.

FIG. 2 is a diagram showing an exemplary configuration of a connection form among computer systems.

FIG. 3 is a block diagram showing a second exemplary embodiment of the present invention.

FIG. 4 is a diagram showing an exemplary configuration of lending resource information according to the second exemplary embodiment of the present invention.

FIG. 5 is a diagram showing an exemplary configuration of borrowing resource information according to the second exemplary embodiment of the present invention.

FIG. 6 is a diagram showing an exemplary configuration of network information according to the second exemplary embodiment of the present invention.

FIG. 7 is a flowchart showing exemplary processing performed by a retrieval section according to the second exemplary embodiment of the present invention.

FIG. 8 is a block diagram showing a third exemplary embodiment of the present invention.

FIG. 9 is a diagram showing an exemplary configuration of free line information according to the third exemplary embodiment of the present invention.

FIG. 10 is a block diagram showing a fourth exemplary embodiment of the present invention.

FIG. 11 is a diagram showing an exemplary configuration of borrowing resource information according to the fourth exemplary embodiment of the present invention.

FIG. 12 is a diagram showing an exemplary configuration of quality information according to the fourth exemplary embodiment of the present invention.

### EXEMPLARY EMBODIMENTS

Next, exemplary embodiments of the present invention will be described in detail with reference to the drawings.

### First Exemplary Embodiment

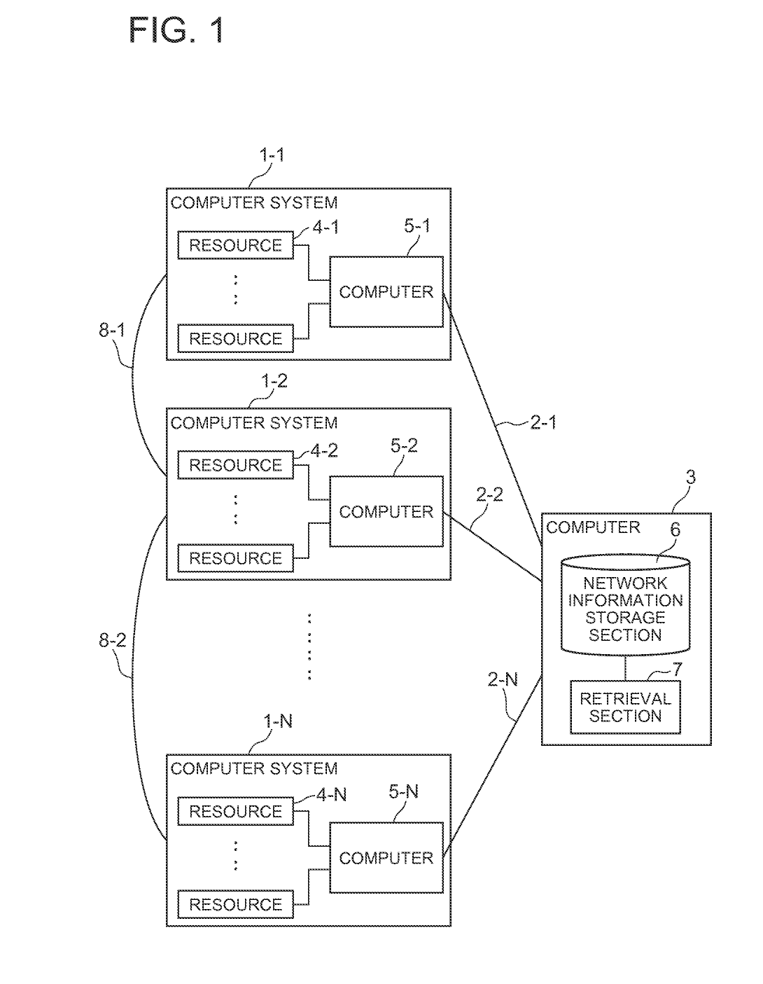

Referring to FIG. 1, a first exemplary embodiment of the present invention includes a plurality of computer systems 1, a computer 3, communication channels 2 connecting the computer systems 1 and the computer 3, and networks 8 connecting the computer systems 1 with one another.

The communication channels 2 are communication channels for exchanging messages relating to resource retrieval between the computer 3 and the computer systems 1. The communication channels 2 are configured of dedicated lines, public network lines, or Internet connections, for example.

Each of the computer systems 1 includes one or more resources 4 and a computer 5. The size of each of the computer systems 1 is arbitrary. For example, one computer system 1 may be a data center system, or one of a plurality of computer systems constituting a data center system. The resources 4 are computer resources and network resources necessary for executing programs, and in the present embodiment, they are server computers and storage devices. The computer 5 is one particular computer in each of the computer systems 1, and is communicable with the computer 3 via the communication channel 2.

The networks 8 are networks providing communication channels for transferring business data among the computer systems 1. The network 8 may be wide-area Ethernet (Ethernet is a registered trademark), for example. Each of the computer systems 1 is not necessarily connected with all other computer systems 1 over the networks 8. Some of the computer systems 1 are only connected with part of the other computer systems 1 over the networks 8.

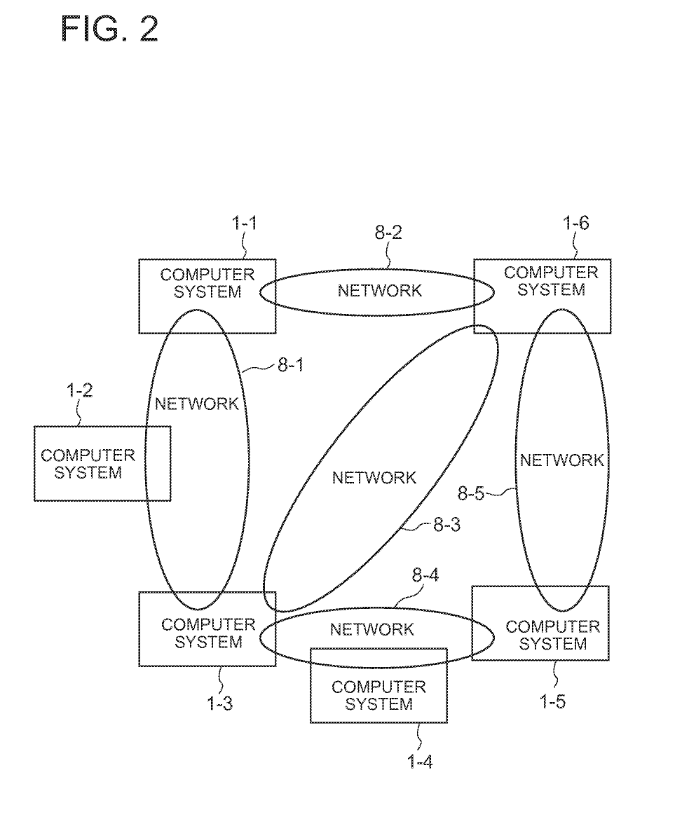

FIG. 2 shows an exemplary configuration of a connection form among the computer systems 1 over the networks 8. In this example, a computer system 1-1 is connected with networks 8-1 and 8-2, a computer system 1-2 is connected with a network 8-1, a computer system 1-3 is connected with networks 8-1, 8-3, and 8-4, a computer system 1-4 is connected with a network 8-4, a computer system 1-5 is connected with networks 8-4 and 8-5, and a computer system 1-6 is connected with networks 8-2, 8-3, and 8-5. Accordingly, the computer system 1-1 is able to exchange business data with the computer systems 1-2 and 1-3 over the network 8-1, and with the computer system 1-6 over the network 8-2, respectively, but is unable to exchange business data with the computer systems 1-4 and 1-5, for example. As such, even if the computer system 1-1 borrows resources of the computer systems 1-4 and 1-5, the computer system 1-1 is unable to execute the business of the computer system 1-1 using the borrowed resources.

The computer 5 transmits a borrowing request message to the computer 3 when the own computer system 1 becomes a borrower of a resource. The borrowing request message includes the type of a resource to be borrowed and the conditions of the resource. Meanwhile, if the own computer system 1 becomes a lender of a resource, the computer 5 transmits, in advance or upon request from the computer 3, a lending request message including the type of a resource to be lent and the conditions of the resource.

The computer 3 is connected with computers 5 of the computer systems 1 via the communication channels 2, and has a function of retrieving a resource satisfying the resource conditions provided in the borrowing request message received from any of the computers 5, from the other computer systems 1. The computer 3 includes a network information storage section 6 and a retrieval section 7.

The network information storage section 6 has a function of storing information relating to the networks 8 connecting the computer systems 1. In the present embodiment, the information relating to the networks 8 must be at least information with which whether the computer systems 1 are connected over the networks 8 is distinguishable, and information of whether or not the line status is free is not always necessary.

The retrieval section 7 has a function of computing a set of other computer systems from which a resource satisfying the resource conditions provided in the borrowing request message is retrieved, based on the information stored in the network information storage section 6. A set to be computed includes all other computer systems which are connected with the borrower computer system over the networks 8, and the other computer systems not connected with the borrower computer system over the networks 8 are not included. The retrieval section 7 also has a function of retrieving a resource satisfying the resource conditions provided in the borrowing request message, from among the resources of the other computer systems included in the computed set.

Hereinafter, operation of the present embodiment will be described by way of example in which the computer system 1-1 is a borrower of a resource.

When the computer 5-1 of the computer system 1-1 wishes to borrow a resource from other computer systems 1, the computer 5-1 transmits a borrowing request message including the type of the resource that it wishes to borrow and the resource conditions, to the computer 3 through the communication channel 2-1.

When the retrieval section 7 of the computer 3 receives the borrowing request message from the computer system 1-1, the retrieval section 7 refers to the network information storage section 6 and computes a set of other computer systems from which a resource satisfying the resource conditions in the borrowing request message is retrieved. Specifically, the retrieval section 7 checks, for each of the other computer systems 1-2 to 1-N, whether or not it is connected with the borrower computer system 1-1 over the network 8 with reference to the network information storage section 6, and computes a set only including the other computer systems connected with the computer system 1-1. For example, in the case of a connection form shown in FIG. 2, three computer systems 1-2, 1-3, and 1-6, connected with the borrower computer system 1-1 over the networks 8-1 and 8-2, are included in the set.

Next, the retrieval section 7 retrieves a resource satisfying the resource conditions in the borrowing request, from the other computer systems 1-2 to 1-N included in the set. Specifically, from the computer systems, of the computer systems 1-2 to 1-N included in the set, which transmit a lending request message including the type of the resource that the system wishes to lend and the resource conditions thereof, to the computer 3 beforehand or when a request is made from the computer 3, the retrieval section 7 retrieves at least one lending resource which is of the same type as the resource type in the borrowing request message and has resource conditions satisfying the resource conditions in the borrowing request message.

When the retrieval section 7 succeeds in the retrieval, the retrieval section 7 determines one of the resources in the retrieval result to be a resource to be accommodated. Then, regarding the determined resource, the retrieval section 7 transmits a resource securement request message to the computer 5-1 of the borrower computer system 1-1, and transmits a resource release request message to the lender computer system 1. The resource securement request message includes the lender computer system 1 and identification information of the lending resource. The resource release request message includes the borrower computer system 1-1 and identification information of the lending resource.

Meanwhile, if the retrieval section 7 fails in the retrieval, the retrieval section 7 transmits a message describing failure of the retrieval, with a copy of the lending request, to the computer 5-1 of the borrower computer system 1-1.

In this way, according to the present embodiment, it is possible to prevent a resource which cannot be accommodated in practice from being retrieved. This is because the computer 3 computes a set of computer systems from which a resource satisfying the resource conditions in a borrowing request message is retrieved and which include other computer systems connected with the borrower computer system over the networks, and retrieves a resource satisfying the resource conditions of the borrower from the resources of the other computer systems included in the computed set.

### Second Exemplary Embodiment

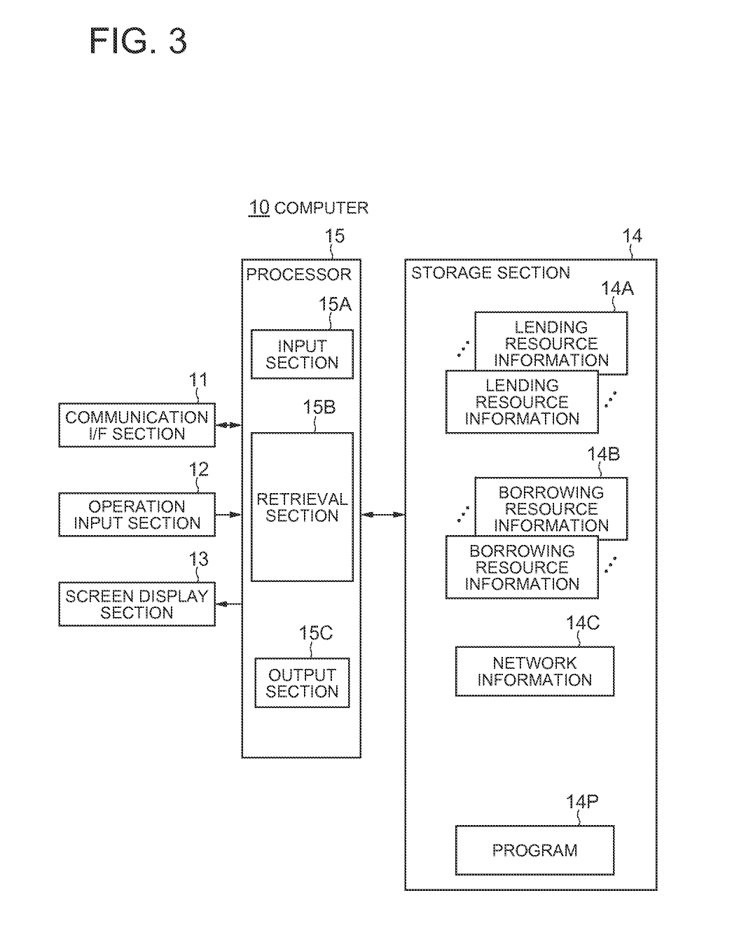

Referring to FIG. 3, a computer 10 according to a second exemplary embodiment of the present invention is connected with a plurality of computer systems 1 each having one or more resources which are computer resources, and has a function of retrieving a resource satisfying the resource conditions received from a borrower computer system of the computer systems 1, from among resources of lender computer systems.

The computer 10 includes, as main function sections, a communication interface section (hereinafter referred to as a communication I/F section) 11, an operation input section 12, a screen display section 13, a storage section 14, and a processor 15.

The communication I/F section 11 is configured of a dedicated data communication circuit, and has a function of performing data communications with various devices such as the computer systems 1 connected through the communication channels 2.

The operation input section 12 is configured of operation input devices such as a keyboard and a mouse, and has a function of detecting operations performed by an operator and outputting them to the processor 15.

The screen display section 13 is configured of a screen display device such as an LCD or a PDP, and has a function of displaying, on the screen, various types of information such as retrieval results in accordance with instructions from the processor 15.

The storage section 14 is configured of storage devices such as a hard disk and a memory, and has a function of storing processing information necessary for various types of processing performed by the processor 15, and programs 14P. The programs 14P are programs which are read and executed by the processor 15 to thereby realize various types of processing sections. The programs 14P are read in advance from external devices (not shown) and storage media (not shown) thorough data input/output functions such as the communication I/F section 11, and are stored in the storage section 14.

Main processing information stored in the storage section 14 includes lending resource information 14A, borrowing resource information 14B, and network information 14C.

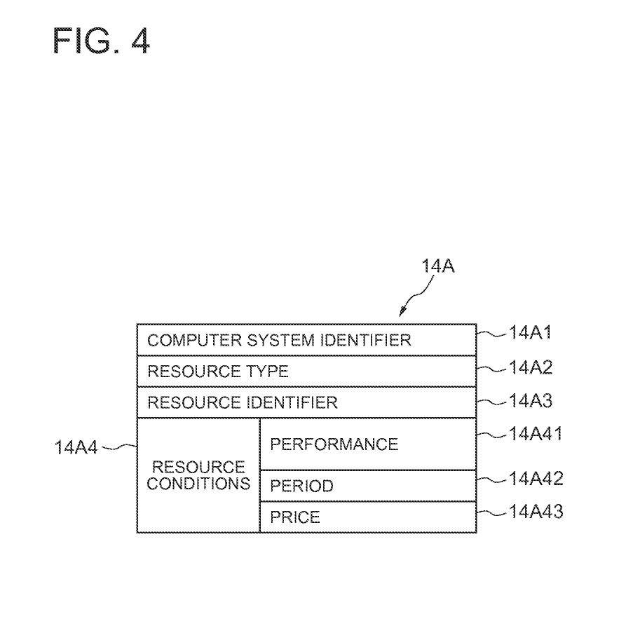

The lending resource information 14A is information relating to a resource to be lent, received from a computer system which is a lender of the resource. FIG. 4 shows an exemplary configuration of the lending resource information 14A. The lending resource information 14A is configured of, for each lending resource, a set of a computer system identifier 14A1 which uniquely identifies the computer system of the lender, a lending resource type 14A2, a resource identifier 14A3 which uniquely identifies the lending resource, and resource conditions 14A4.

In the present embodiment, the resource conditions 14A4 are configured of performance 14A41, period 14A42, and price 14A43. The performance 14A41 is conditions relating to the specification, performance, and capacity of the lending resource. For example, in the case of a server, the performance 14A41 includes CPU type, clock frequency, HDD capacity, and OS type, In the case of a storage, the performance 14A41 includes storage capacity and RAID level. The period 14A42 represents the lending period of the lending resource. The price 14A43 represents the lending price per unit period of the lending resource.

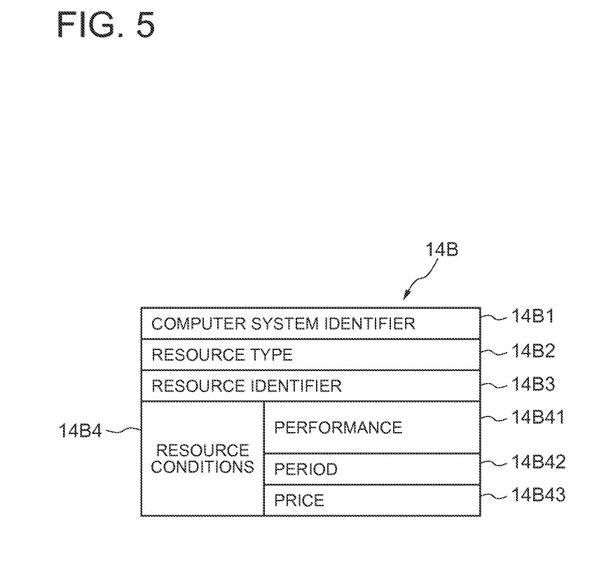

The borrowing resource information 14B is information relating to the borrowing resource received from the computer system which is a resource lender. FIG. 5 shows an exemplary configuration of the borrowing resource information 14B. The borrowing resource information 14B is configured of, for each borrowing resource, a set of a computer system identifier 14B1 which uniquely identifies the borrower computer system, a borrowing resource type 14B2, a resource identifier 14B3 which uniquely identifies a borrowing resource, and resource conditions 14B4.

The resource conditions 14B4 includes performance 14B41, period 14B42, and price 14B43. The performance 14B41 is a condition relating to the specification, performance, and capacity of the borrowing resource. The period 14B42 represents the borrowing period of the borrowing resource. The price 14B43 represents the borrowing price per unit period of the borrowing resource.

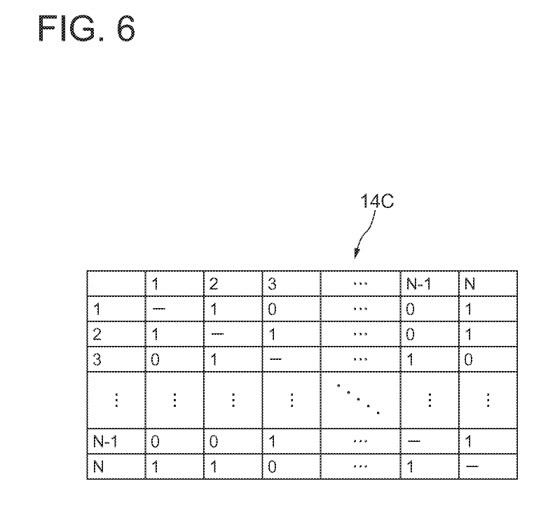

The network information 14C is information regarding the network 8 which connects the computer systems 1 with each other. FIG. 6 shows an exemplary configuration of the network information 14C. The network information 14C is matrix data in which identifiers of the computer systems 1 take the vertical and horizontal axes, and presence or absence of network connection is associated at the intersections of the axes. For example, at the intersection between the first row and the second column, a logical value “1” is stored. This shows that a computer system 1 identified by a computer identifier “1” on the first row and a computer system 1 identified by a computer identifier “2” on the second column are connected over the network 8. Further, at the intersection between the first row and the third column, a logical value “0” is stored. This shows that the computer system 1 identified by the computer identifier “1” on the first row and a computer system 1 identified by a computer identifier “3” on the third column are not connected over the network 8.

The processor 15 includes a microprocessor such as a CPU and the peripheral circuitry thereof, and has a function of reading and executing a program 14P from the storage section 14 so as to realize various types of processing sections by allowing the hardware and the program 14P to operate in cooperation with each other. The main processing sections realized by the processor 15 include an input section 15A, a retrieval section 15B, and an output section 15C.

The input section 15A has a function of storing the lending resource information 14A, the borrowing resource information 14B, and the network information 14C, input from the communication I/F section 11 or the operation input section 12, in the storage section 14.

The retrieval section 15B has a function of, for each piece of the borrowing resource information 14B, retrieving a resource satisfying the resource conditions required by the borrower, from the lending resource information 14A of other computer systems connected over the network with the computer system which is the borrower of the resource.

The output section 15C has a function of notifying the borrower computer system and the lender computer system of the retrieval result of the retrieval section 15B, and displaying it on the screen display section 13.

Next, operation of the present embodiment will be described.

When the input section 15A receives a message including lending resource information from the lender computer system 1 via the communication I/F section 11, the input section 15A stores it in the storage section 14 as one piece of the lending resource information 14A. As the input section 15A performs processing preferentially in order of arrival, the lending resource information 14A may be stored in a queue of a first-in first-out method.

Further, when the input section 15A receives the message including the borrowing resource information from the borrower computer system 1 via the communication I/F section 11, the input section 15A stores it as one piece of the borrowing resource information 14B in the storage section 14. As the input section 15A performs processing preferentially in order of arrival, the borrowing resource information 14B may be stored in a queue of a first-in first-out method.

When the input section 15A receives network information via the communication I/F section 11 or the operation input section 12, the input section 15A stores it in the storage section 14 as the network information 14C.

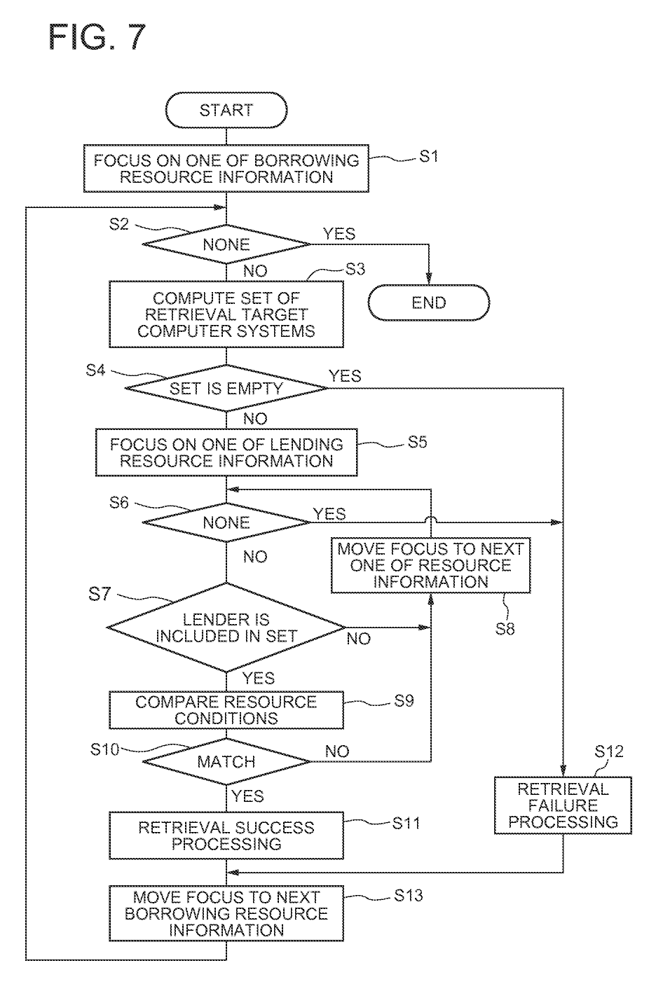

Next, operation of the retrieval section 15B and the output section 15C will be described. FIG. 7 is a flowchart showing the operation of the retrieval section 15B. The retrieval section 15B performs the processing shown in FIG. 7 each time a predetermined period has elapsed. The processing shown in FIG. 7 is performed in parallel with processing to store new lending resource information and borrowing resource information in the storage section 14. The total period of time which can be used for the processing shown in FIG. 7 is set in advance, and if the processing is not completed within a given period of time after the beginning of the processing of FIG. 7, the processing of FIG. 7 is adapted to be stopped forcibly.

First, the retrieval section 15B reads one piece of the borrowing resource information 14B from the storage section 14, and focuses on such borrowing resource information 14B (step S1). Then, after confirming that there is focused borrowing resource information 14B (step S2), the retrieval section 15B computes a set of retrieval target computer systems (step S3). Specifically, the retrieval section 15B reads a computer system identifier 14B1 of the borrower from the focused borrowing resource information 14B. Then, the retrieval section 15B reads the matrix (FIG. 6) of the network information 14C from the storage section 14, and extracts the row of the computer system identifier 14B1 of the borrower. Then, the retrieval section 15B extracts all computer system identifiers corresponding to the columns where the value of each column on the extracted row takes a logical value 1. Then, the retrieval section 15B determines a set including the extracted identifiers to be a set of retrieval target computer systems.

Then, the retrieval section 15B determines whether or not the set is empty (step S4). If the set is empty, the retrieval section 15B performs retrieval failure processing (step S12). In the retrieval failure processing, the retrieval section 15B compares the start time of the period 14B42 in the focused borrowing resource information 14B with the current time, and determines whether or not the current time is before the “start time−α (α is a predetermined spare time)”. If the current time is before the “start time−α”, the retrieval section 15B writes back the focused borrowing resource information 14B at the end of the queue of the borrowing resource information in the storage section 14. On the other hand, if the current time is the “start time−α” or after, the retrieval section 15B notifies the computer system identified by the computer system identifier 14B1 in the focused borrowing resource information 14B of the retrieval failure with the focused borrowing resource information 14B via the output section 15C and the communication I/F section 11. Then, the retrieval section 15B reads the next one piece of the borrowing resource information 14B from the storage section 14, and then focuses on such borrowing resource information 14B (step S13). Then, the retrieval section 15B returns to step S2.

On the other hand, if the set is not empty, the retrieval section 15B reads one piece of the lending resource information 14A from the storage section 14, and focuses on such lending resource information 14A (step S5). Then, after confirming that there is focused lending resource information 14A (step S6), the retrieval section 15B determines whether or not a computer system identifier 14A1 in the focused lending resource information 14A is included in the set (step S7). If it is not included, after writing back the focused lending resource information 14A at the end of the queue of the lending resource information in the storage section 14, the retrieval section 15B reads the next one piece of the lending resource information 14A from the storage section 14, and moves focus to such lending resource information 14A (step S8). Then, the retrieval section 15B returns to step S6.

If the computer system identifier 14A1 in the focused lending resource information 14A is included in the set, the retrieval section 15B compares the resource conditions 14B4 in the focused borrowing resource information 14B with the resource conditions 14A4 in the focused lending resource information 14A, and determines whether or not they match (steps S9, S10). Comparison between the resource conditions is performed between performances, between periods, and between prices. If they match in all of the three aspects of performances, periods, and prices, the retrieval section 15B determines that the lending resource and the resource conditions of the borrowing resource match.

In the comparison between the performances, regarding those other than numeral values such as CPU types and OS types, if the performance of the lending resource are the same as or compatible with the performance of the borrowing resource, they are determined to match. Further, in the case of numeral values such as clock frequencies and HDD capacities, only if the numeral value of the borrowing resource is not larger than the numeral value of the lending resource and the difference between them is not larger than a predetermined quantity, for example, they are determined to match. In the comparison between the periods, only if the borrowing period of the borrowing resource is within the lending period of the lending resource and the difference between the start date/time and the difference between the ending date/time of the both periods are not more than a predetermined quantity, for example, they are determined to match. In the comparison between the prices, only if the borrowing price of the borrowing resource is not higher than the lending price of the lending resource and the difference between them is not more than a predetermined value, for example, they are determined to match. Of course, the method of comparing performances, periods, and prices is not limited to that described above, and any methods can be adopted.

When the retrieval section 15B founds the lending resource information 14A matching the focused borrowing resource information 14B, the retrieval section 15B performs retrieval success processing (step S11). In the retrieval success processing, the retrieval section 15B notifies the computer system, identified by the computer system identifier 14B1 in the focused borrowing resource information, of a resource securement request message along with the focused borrowing resource information 14B and the matched lending resource information 14A, via the output section 15C and the communication I/F section 11. Further, the retrieval section 15B notifies the computer system, identified by the computer system identifier 14A1 in the focused lending resource information 14A, of a resource release request message along with the focused lending resource information 14A and the matched borrowing resource information 14B, via the output section 15C and the communication I/F section 11. Then, the retrieval section 15B reads the next one piece of the borrowing resource information 14B from the storage section 14, and moves focus to such borrowing resource information 14B (step S13). Then, the retrieval section 15B returns to step S2.

At step S2, when the retrieval section 15B detects that there is no borrowing resource information 14B to be focused any more, the retrieval section 15B ends the processing of FIG. 7. It should be noted that in order to eliminate the waste of repeated processing of the same borrowing resource information under the condition where no lending resource information has been newly added, if no additional lending resource information has been registered, the retrieval section 15B may end the processing of FIG. 7 when the borrowing resource information, which has been processed, is located at the head of the queue again.

In the processing of FIG. 7, when the lending resource information 14A matching the borrowing resource information 14B has been found, the lending resource according to the lending resource information 14A is determined to be a resource to be accommodated. However, as another method, it is also possible to retrieve a plurality of (or all) pieces of the lending resource information 14A matching the borrowing resource information 14B, and determine a resource to be accommodated from among the pieces of the lending resource information. As a method of determining a resource to be accommodated from among the retrieved pieces of the lending resource information 14A, a piece of the lending resource information 14A of the lowest lending price may be selected. Meanwhile, a method of a lowest price lender and a second lowest price, in which the computer system 1 of the lending resource information 14A having the lowest lending price is selected as the lender, but the price is set not to be the lowest price but to be the second lowest price, may be adopted.

In contrast to the processing of FIG. 7, it is also possible to retrieve a plurality of pieces of the borrowing resource information 14B matching the lending resource information 14A, and determine a borrower from the retrieved pieces of the borrowing resource information 14B. As a method of determining a borrower from the retrieved pieces of the borrowing resource information 14B, a method of selecting a piece of the borrowing resource information 14B of the highest borrowing price may be used.

As described above, according to the present embodiment, it is possible to prevent a resource which cannot be accommodated in practice from being retrieved. This is because the computer 10 computes a set of computer systems 1 from which a resource satisfying the resource conditions of the borrower is retrieved and which do not include other computer systems 1 not connected with the borrower computer system 1 over the network 8, and retrieves a resource satisfying the resource conditions required by the borrower from among the resources of the other computer systems 1 included in the computed set.

In particular, the present embodiment is preferable for the case where the computer systems 1 are connected with one another over the network 8 having a sufficient bandwidth.

### Third Exemplary Embodiment

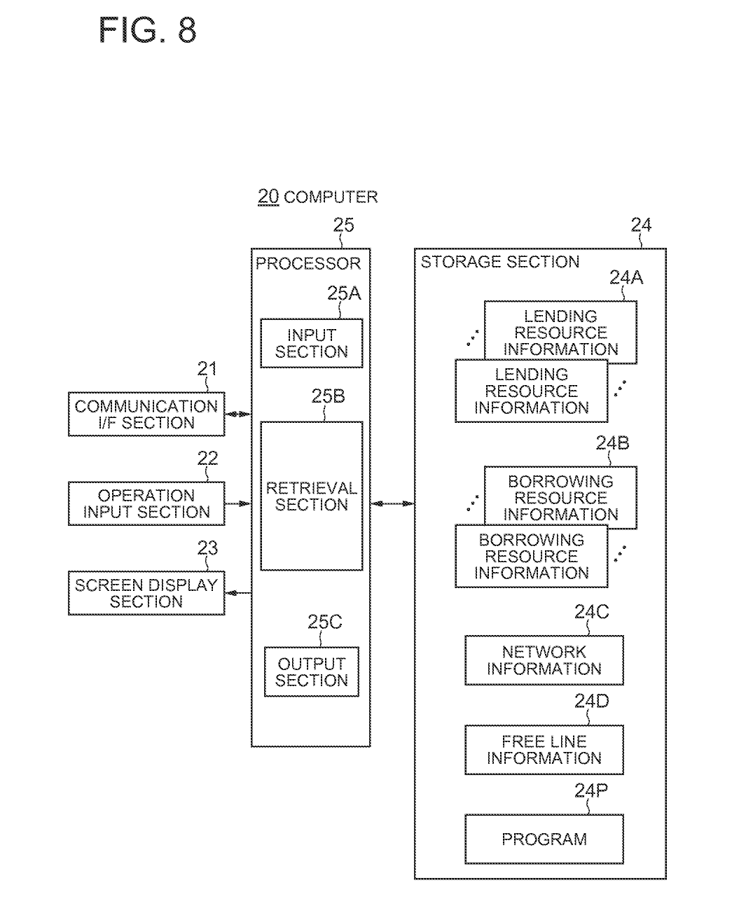

Referring to FIG. 8, a computer 20 according to a third exemplary embodiment of the present invention is connected with a plurality of computer systems 1 each having one or more resources which are computer resources, and has a function of retrieving a resource satisfying the resource conditions received from a borrower computer system 1 of the computer systems 1, from the resources of lender computer systems 1, in consideration of a free line of the networks among the computer systems.

The computer 20 includes, as main function sections, a communication I/F section 21, an operation input section 22, a screen display section 23, a storage section 24, and a processor 25.

The communication I/F section 21, the operation input section 22, and the screen display section 23 are the same as the communication I/F section 11, the operation input section 12, and the screen display section 13 of the second exemplary embodiment.

The storage section 24 is configured of storage devices such as a hard disk and a memory, and has a function of storing processing information necessary for various types of processing performed by the processor 25, and programs 24P. The programs 24P are programs which are read and executed by the processor 25 to thereby realize various types of processing sections. The programs 24P are read in advance from external devices (not shown) and storage media (not shown) thorough data input/output functions such as the communication I/F section 21, and are stored in the storage section 24.

Main processing information stored in the storage section 24 includes lending resource information 24A, borrowing resource information 24B, network information 24C, and free line information 24D.

The lending resource information 24A, the borrowing resource information 24B, and the network information 24C are the same as the lending resource information 14A, the borrowing resource information 14B, and the network information 14C of the second exemplary embodiment.

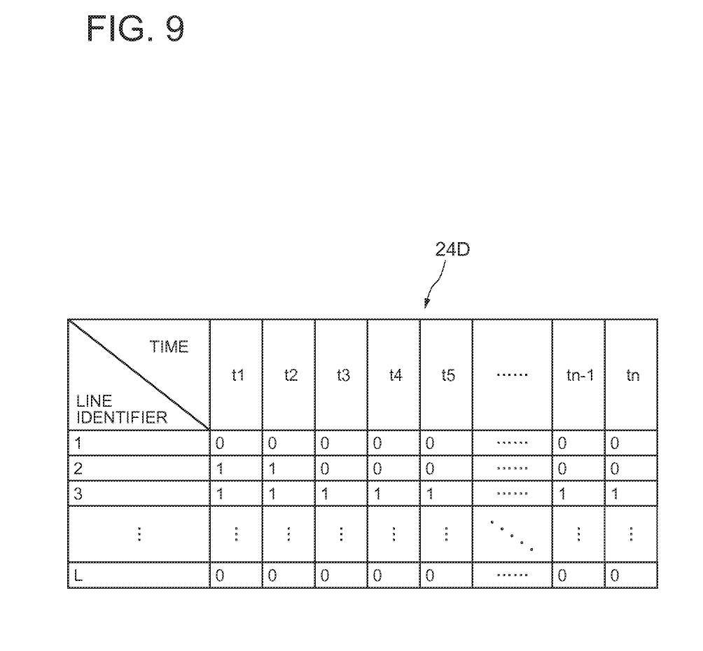

The free line information 24D is information of a free line of the network 8 connecting the computer systems 1 with one another. FIG. 9 shows an exemplary configuration of the free line information 24D. The free line information 24D shows information of a free line of the network connecting a computer system 1-1 and a computer system 1-2. In the connection form shown in FIG. 2, for example, free statuses of the lines used for communications between the computer system 1-1 and the computer system 1-2, among all of the lines of the network 8-1, are shown. The free line information 24D is matrix data in which line identifiers take the vertical axis and the time zones take the horizontal axis, and at each of the intersections thereof, presence or absence of a free line is associated. For example, at the intersection between the first row and the first column, a logical value “0” is stored. This means that the line identified by the line identifier “1” on the first row is able to secure a required bandwidth in a period identified by the time zone t1 on the first column. In the case where a required bandwidth is able to be secured in a given time zone for a given line, as in this case, it is said that the line is free in that time zone (not scheduled to be used). Further, at the intersection between the second row and the first column, a logical value “1” is stored. This means that the line identified by the line identifier “1” on the first row is unable to secure a required bandwidth in a period specified by the time zone t1 on the first column. In this case, it is said that the line is busy (scheduled to be used). It should be noted that in the case of packet communications in which the total bandwidth of a line and the guaranteed minimum bandwidth when the line is used are different, multiple use is possible simultaneously even in one line. In that case, the line may be indicated as free (“0”) as long as the sum of the guaranteed minimum bandwidths of the multiple use is below the total bandwidth.

The processor 25 includes a microprocessor such as a CPU and the peripheral circuitry thereof, and has a function of reading and executing a program 24P from the storage section 24 so as to realize various types of processing sections by allowing the hardware and the program 24P to operate in cooperation with each other. The main processing sections realized by the processor 25 include an input section 25A, a retrieval section 25B, and an output section 25C.

The input section 25A has a function of storing the lending resource information 24A, the borrowing resource information 24B, and the free line information 24D input from the communication I/F section 21 or the operation input section 22 in the storage section 24. The input section 25A also has a function of generating the network information 24C in the initial state and storing it in the storage section 24, when storing the free line information 24D.

The retrieval section 25B has a function of, for each piece of the borrowing resource information 24B, retrieving a resource satisfying the resource conditions required by the borrower, from the lending resource information 24A of other computer systems 1 connected over the network 8 with the computer system 1 which is the borrower of the resource.

The output section 25C has a function of notifying the borrower computer system 1 and the lender computer system 1 of the retrieval result of the retrieval section 25B, and displaying it on the screen display section 23.

Next, operation of the present embodiment will be described.

When the input section 25A receives a message including lending resource information from the lender computer system 1 via the communication I/F section 21, the input section 25A stores it in the storage section 24 as one piece of the lending resource information 24A. As the input section 25A performs processing preferentially in order of arrival, the lending resource information 24A may be stored in a queue of a first-in first-out method.

When the input section 25A receives the message including the borrowing resource information from the borrower computer system 1 via the communication I/F section 21, the input section 25A stores it as one piece of the borrowing resource information 24B in the storage section 24. As the input section 25A performs processing preferentially in order of arrival, the borrowing resource information 24B may be stored in a queue of a first-in first-out method.

Further, when the input section 25A receives free line information via the communication I/F section 21 or the operation input section 22, the input section 25A stores it in the storage section 24 as free line information 24D. Then, based on the free line information 24D, the input section 25A generates network information 24C in the initial state, and stores it in the storage section 24. Specifically, the input section 25A generates matrix data in which predetermined identifiers of all of the computer systems 1 take the vertical and horizontal axes, and at each of the intersections of the axes, a logical value “0” (non-connected) is stored. Then, the input section 25A performs the following processing for each piece of the free line information 24D; that is, in the case where the free line information 24D is free line information of the network between two computer systems identified by the computer system identifiers “1” and “2”, for example, if a logical value “0” (free) is set in any time zone ahead of the time of “current time−α (α is predetermined spare time)” for either one line identifier, the input section 25A rewrites the value at the intersection between the identifiers of the two computer systems in the network information 24C, from the logical value “0” (non-connected) to a logical value “1” (connected). The input section 25A repeats this processing for all pieces of the free line information 24D.

Next, operation of the retrieval section 25B will be described. The overall flow of the operation follows the flowchart of FIG. 7, as the case of the retrieval section 15B in the second exemplary embodiment. However, the following aspect differs from the operation of the retrieval section 15B.

In the comparison of resource conditions at step S9, the retrieval section 25B also checks presence or absence of a free line of the network 8, and if resource conditions are satisfied and there is a free line in the network 8 connecting the borrower computer system 1 and the lender computer system 1 in the period (14B42) of the borrowing resource conditions, the retrieval section 25B determines that they “match”. Whether or not there is a free line in the period (14B42) of the borrowing resource is determined with reference to the free line information 24D according to the network 8 connecting the borrower computer system 1 and the lender computer system 1.

In the retrieval success processing at step S11, the retrieval section 25B updates the free line information 24D, and also updates the network information 24C as needed. Specifically, the retrieval section 25B rewrites the logical value “0” (free) of any one of the lines in which the logical values are “0” (free) during the period of the borrowing resource in the free line information 24D according to the network 8 connecting the borrower computer system 1 and the lender computer system 1, to a logical value “1” (busy). Further, due to the rewriting, if there is no line in which a logical value “0” (free) is set in any time zone ahead of the time of “current time−α”, the retrieval section 25B rewrites the value at the intersection corresponding to the borrower computer system 1 and the lender computer system 1 in the network information 24C, from a logical value “1” (connected) to a logical value “0” (non-connected).

As described above, according to the present embodiment, it is possible to prevent a resource which cannot be accommodated in practice from being retrieved. This is because the computer 20 computes a set of computer systems 1 from which a resource satisfying the resource conditions of the borrower is retrieved, the set including other computer systems 1 connected with the borrower computer system 1 over the network 8 having a free line, and retrieves a resource satisfying the resource conditions of the borrower from among the resources of the other computer systems 1 included in the computed set.

In particular, the present embodiment is preferable for the case where the network 8 connecting the computer systems 1 does not have a sufficient bandwidth.

### Fourth Exemplary Embodiment

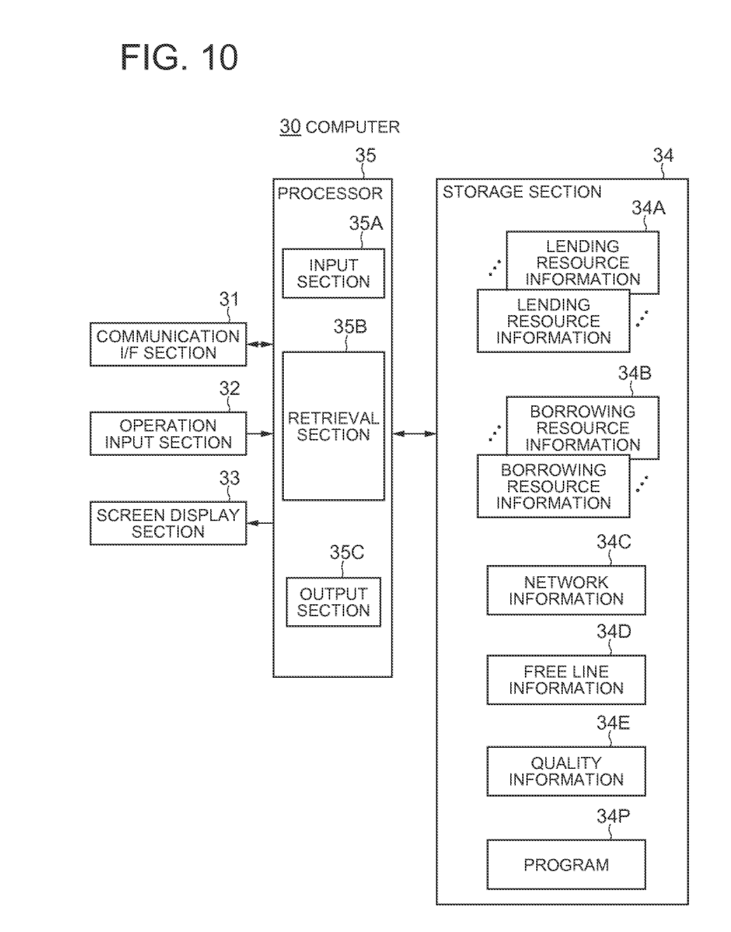

Referring to FIG. 10, a computer 30 according to a fourth exemplary embodiment of the present invention is connected with a plurality of computer systems 1 each having one or more resources which are computer resources, and has a function of retrieving a resource satisfying the resource conditions received from a borrower computer system 1 of the computer systems 1, from among the resources of lender computer systems 1, in consideration of a free line and the quality of the networks among the computer systems.

The computer 30 includes, as main function sections, a communication I/F section 31, an operation input section 32, a screen display section 33, a storage section 34, and a processor 35.

The communication I/F section 31, the operation input section 32, and the screen display section 33 are the same as the communication I/F section 21, the operation input section 22, and the screen display section 23 of the third exemplary embodiment.

The storage section 34 is configured of storage devices such as a hard disk and a memory, and has a function of storing processing information necessary for various types of processing performed by the processor 35 and programs 34P. The programs 34P are programs which are read and executed by the processor 35 to thereby realize various types of processing sections. The programs 34P are read in advance from external devices (not shown) and storage media (not shown) thorough data input/output functions such as the communication I/F section 31, and are stored in the storage section 34.

Main processing information stored in the storage section 34 includes lending resource information 34A, borrowing resource information 34B, network information 34C, free line information 34D, and quality information 34E.

The lending resource information 34A, the network information 34C, and the free line information 34D are the same as the lending resource information 24A, the network information 24C, and the free line information 24D of the third exemplary embodiment.

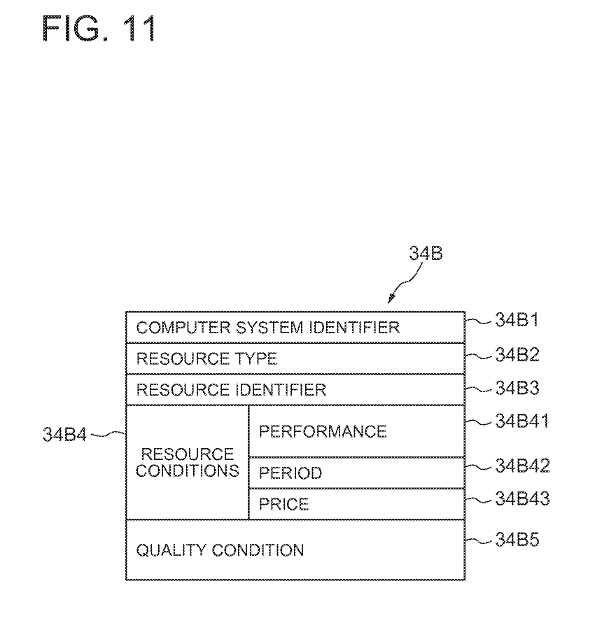

The borrowing resource information 34B is information relating to a borrowing resource received from a computer system which is a borrower of the resource. FIG. 11 shows an exemplary configuration of the borrowing resource information 34B including quality information of the network. In FIG. 11, a computer system identifier 34B1, a resource type 34B2, a resource identifier 34B3, and performance 34B41, period 34B42, and price 34B43 of resource conditions are the same as the computer system identifier 14B1, the resource type 14B2, the resource identifier 14B3, and the performance 14B41, the period 14B42, and the price 14B43 of the resource conditions in the borrowing resource information 14B shown in FIG. 15. The quality conditions 34B5 in FIG. 11 are conditions that a network must satisfy, which are required by the borrower. For example, the quality conditions 34B5 show conditions for quality which should be satisfied, such as a lower limit value of a bandwidth and an upper limit value of a delay time (maximum acceptable value).

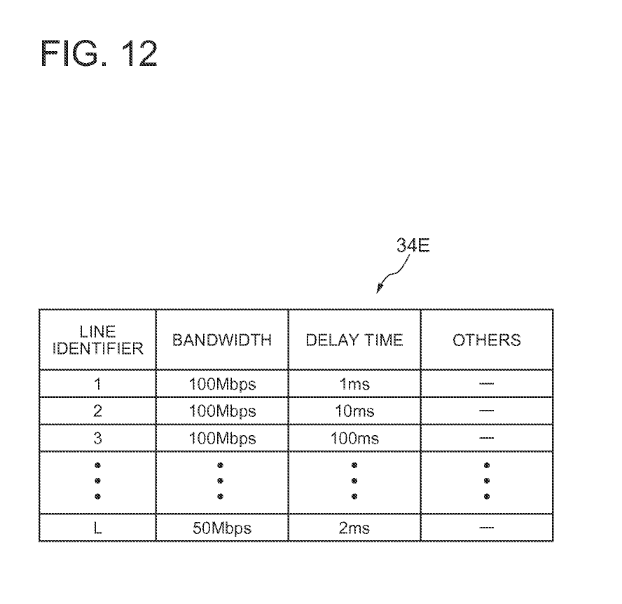

The quality information 34E is quality information of communication lines of the network 8 connecting the computer systems 1 with one another. FIG. 12 shows an exemplary configuration of the quality information 34E. The quality information 34E shows quality information of the network 8 connecting the computer system 1-1 and the computer system 1-2. For example, the connection form shown in FIG. 2 shows quality information of the line to be used for communications between the computer system 1-1 and the computer system 1-2, among all lines of the network 8-1. The quality information 34E records the bandwidth, delay time, and other types of quality information as quality information, corresponding to a line identifier. For example, it shows that the line identified by the line identifier “1” on the first row has a bandwidth of 100 Mbps and the delay time is 1 ms at maximum. As other types of quality information, packet loss rate, bit error rate, availability, and the like may be included, for example. While the quality information is held by each line in the example of FIG. 12, it is possible to record quality information for each group of lines having the same quality, or record the quality information by each network if all of the lines between the computer system 1-1 and the computer system 1-2 have the same quality. Further, the quality information does not necessarily include all of the bandwidth, delay time, packet loss rate, bit error rate, and availability mentioned above. It may include one or two of them.

The processor 35 includes a microprocessor such as a CPU and peripheral circuitries thereof, and has a function of reading and executing the program 34P from the storage section 34 so as to realize various types of processing sections by allowing the hardware and the program 34P to operate in cooperation with each other. The main processing sections realized by the processor 35 include an input section 35A, a retrieval section 35B, and an output section 35C.

The input section 35A has a function of storing the lending resource information 34A, the borrowing resource information 34B, the free line information 34D, and the quality information 34E, input from the communication I/F section 31 or the operation input section 32, in the storage section 34. The input section 35A also has a function of generating the network information 34C in the initial state and storing it in the storage section 34, when storing the free line information 34D, which is the same as the input section 25A in the third exemplary embodiment.

The retrieval section 35B has a function of, for each piece of the borrowing resource information 34B, retrieving a resource satisfying the resource conditions required by the borrower, from the lending resource information 34A of other computer systems connected over the network 8 with the computer system 1 which is the borrower of the resource.

The output section 35C has a function of notifying the borrower computer system 1 and the lender computer system 1 of the retrieval result of the retrieval section 35B, and displaying it on the screen display section 33.

Next, operation of the present embodiment will be described.

When the input section 35A receives a message including lending resource information from a lender computer system 1 via the communication I/F section 31, the input section 35A stores it in the storage section 34 as one piece of the lending resource information 34A. As the input section 35A performs processing preferentially in order of arrival, the lending resource information 34A may be stored in a queue of a first-in first-out method.

Further, when the input section 35A receives a message including borrowing resource information from a borrower computer system 1 via the communication I/F section 31, the input section 35A stores it as one piece of the borrowing resource information 24B in the storage section 34. As the input section 35A performs processing preferentially in order of arrival, the borrowing resource information 34B may be stored in a queue of a first-in first-out method.

Further, when the input section 35A receives free line information and quality information via the communication I/F section 31 or the operation input section 32, the input section 35A stores them in the storage section 34 as the free line information 34D and the quality information 34E. Then, based on the free line information 34D, the input section 35A generates the network information 34C in the initial state, and stores it in the storage section 34.

Next, operation of the retrieval section 35B will be described. The overall flow of the operation follows the flowchart of FIG. 7, as the case of the retrieval section 25B in the third exemplary embodiment. However, the following aspect differs from the operation of the retrieval section 25B.

In the comparison of resource conditions at step S9, the retrieval section 25B checks not only presence or absence of a free line in the network 8 but also quality of the network 8, and if the resource conditions match and there is a free line in the network 8 which connects the borrower computer system 1 and the lender computer system 1 in the period (14B42) of the borrowing resource conditions, and further, if the quality of the free line satisfies the desired quality, the retrieval section 25B determines that they “match”. The quality of the line is acquired with reference to the quality information 34E according to the network 8 connecting the borrower computer system 1 and the lender computer system 1. The retrieval section 25B determines whether or not the acquired quality satisfies the desired quality. As the desired quality, the quality condition 34B5 in the borrowing resource information 34B shown in FIG. 11 is used in the present embodiment.

As described above, according to the present embodiment, it is possible to retrieve a resource in consideration of the state of a free line and the quality condition of the network between the computer systems 1.

### Other Exemplary Embodiments

While the present invention has been described with reference to the exemplary embodiments described above, the present invention is not limited to the above-described embodiments, and various additions and modifications can be made therein. For example, in the third and fourth exemplary embodiments, the free line information 24D and the free line information 34D are kept for all of the networks 8 connecting the computer systems 1. However, it is possible to divide all of the networks 8 connecting the computer systems 1 into networks having a sufficient bandwidth and the other networks, and keep the free line information 24D and the free line information 34D only for the latter networks (networks not having a sufficient bandwidth).

The present invention is based upon and claims the benefit of priority from Japanese patent application No. 2011-170768, filed on Aug. 4, 2011, the disclosure of which is incorporated herein in its entirety by reference.

### INDUSTRIAL APPLICABILITY

The present invention is applicable to overall resource retrieval for resource accommodation between computer systems such as cloud computing systems, grid computing systems, and data center systems.

The whole or part of the exemplary embodiments disclosed above can be described as, but not limited to, the following supplementary notes.

### (Supplementary Note 1)

A computer connected with a plurality of computer systems each having one or more resources, the resources being a computer resource and a network resource, the computer comprising:

network information storage means for storing information relating to a network connecting a first computer system and second computer systems, the first computer system being a particular computer system of the plurality of the computer systems, the second computer systems being computer systems other than the particular computer system; and

retrieval means for computing a set of the second computer systems connected with the first computer system over the network based on the information relating to the network stored in the network information storage means, and retrieving a resource to be provided for use in the first computer system, from among resources held by the second computer systems included in the computed set.

### (Supplementary Note 2)

The computer according to supplementary note 1, wherein

the retrieval means retrieves a resource satisfying a resource condition required by the first computer system as the resource to be provided for use in the first computer system, from among the resources held by the second computer systems included in the set.

### (Supplementary Note 3)

The computer according to supplementary note 1, wherein

the information relating to the network connecting the first computer system and the second computer systems includes matrix data in which identifiers of the first computer system and the second computer systems take a vertical axis and a horizontal axis, and presence or absence of a network connection is associated at each of intersections of the axes, and

the retrieval means computes the set based on the matrix data, and retrieves a resource satisfying a resource condition required by the first computer system as the resource to be provided for use in the first computer system, from among the resources held by the second computer systems included in the computed set.

### (Supplementary Note 4)

The computer according to supplementary note 1, wherein

the information relating to the network connecting the first computer system and the second computer systems includes:
matrix data in which identifiers of the first computer system and the second computer systems take a vertical axis and a horizontal axis, and presence or absence of a network connection is associated at each of intersections of the axes; and
free line information, per unit time, of the network connecting the first computer system and the second computer systems, and

the retrieval means computes the set based on the matrix data, and retrieves a resource satisfying a resource condition required by the first computer system as the resource to be provided for use in the first computer system, from among the resources held by the second computer systems which are included in the computed set and in which a free line is present in the network with the first computer system.

### (Supplementary Note 5)

The computer according to supplementary note 1, wherein

the information relating to the network connecting the first computer system and the second computer systems includes:
matrix data in which identifiers of the first computer system and the second computer systems take a vertical axis and a horizontal axis, and presence or absence of a network connection is associated at each of intersections of the axes;
free line information, per unit time, of the network connecting the first computer system and the second computer systems; and
quality information of the network, and

the retrieval means computes the set based on the matrix data, and retrieves a resource satisfying a resource condition required by the first computer system as the resource to be provided for use in the first computer system, from among the resources held by the second computer systems which are included in the computed set and in which a free line satisfying quality required by the first computer system is present in the network with the first computer system.

### (Supplementary Note 6)

The computer according to supplementary note 4 or 5, wherein

when the retrieval means has determined a resource to be provided for use in the first computer system, the retrieval means updates the free line information of the network connecting the second computer system having the determined resource and the first computer system, by a quantity to be used by the determined resource.

### (Supplementary Note 7)

The computer according to supplementary note 6, wherein

if there is no free line any more in the network connecting the first computer system and the second computer systems due to updating of the free line information of the network, the retrieval means updates a value of a corresponding intersection in the matrix data to a state in which there is no network connection.

### (Supplementary Note 8)

The computer according to supplementary note 6 or 7, wherein

the resource condition includes a condition relating to a period, and

the retrieval means updates the free line information of the network according to the period included in the resource condition.

### (Supplementary Note 9)

A resource retrieval method to be executed by a computer connected with a plurality of computer systems each having one or more resources, the resources being a computer resource and a network resource, the computer including network information storage means for storing information relating to a network connecting a first computer system and second computer systems, the first computer system being a particular computer system of the plurality of the computer systems, the second computer systems being computer systems other than the particular computer system, the method comprising:

computing a set of the second computer systems connected with the first computer system over the network, based on the information relating to the network stored in the network information storage means; and

retrieving a resource to be provided for use in the first computer system, from among resources held by the second computer systems included in the computed set.

### (Supplementary Note 10)

The resource retrieval method according to supplementary note 9, wherein

the retrieving includes retrieving a resource satisfying a resource condition required by the first computer system as the resource to be provided for use in the first computer system, from among the resources held by the second computer systems included in the set.

### (Supplementary Note 11)

The resource retrieval method according to supplementary note 9, wherein

the information relating to the network connecting the first computer system and the second computer systems includes matrix data in which identifiers of the first computer system and the second computer systems take a vertical axis and a horizontal axis, and presence or absence of a network connection is associated at each of intersections of the axes,

the computing includes computing the set based on the matrix data, and

the retrieving includes retrieving a resource satisfying a resource condition required by the first computer system as the resource to be provided for use in the first computer system, from among the resources held by the second computer systems included in the computed set.

### (Supplementary Note 12)

The resource retrieval method according to supplementary note 9, wherein

the information relating to the network connecting the first computer system and the second computer systems includes:
matrix data in which identifiers of the first computer system and the second computer systems take a vertical axis and a horizontal axis, and presence or absence of a network connection is associated at each of intersections of the axes; and
free line information, per unit time, of the network connecting the first computer system and the second computer systems,

the computing includes computing the set based on the matrix data, and

the retrieving includes retrieving a resource satisfying a resource condition required by the first computer system as the resource to be provided for use in the first computer system, from among the resources held by the second computer systems which are included in the computed set and in which a free line is present in the network with the first computer system.

### (Supplementary Note 13)

The resource retrieval method according to supplementary note 9, wherein

the information relating to the network connecting the first computer system and the second computer systems includes:
matrix data in which identifiers of the first computer system and the second computer systems take a vertical axis and a horizontal axis, and presence or absence of a network connection is associated at each of intersections of the axes;
free line information, per unit time, of the network connecting the first computer system and the second computer systems; and
quality information of the network,

the computing includes computing the set based on the matrix data, and

the retrieving includes retrieving a resource satisfying a resource condition required by the first computer system as the resource to be provided for use in the first computer system, from among the resources held by the second computer systems which are included in the computed set and in which a free line satisfying quality required by the first computer system is present in the network with the first computer system.

### (Supplementary Note 14)

The resource retrieval method according to supplementary note 12 or 13, wherein

the retrieving includes, when a resource to be provided for use in the first computer system has been determined, updating the free line information of the network connecting the second computer system having the determined resource and the first computer system, by a quantity to be used by the determined resource.

### (Supplementary Note 15)

The resource retrieval method according to supplementary note 14, wherein

the retrieving includes, if there is no free line any more in the network connecting the first computer system and the second computer systems due to updating of the free line information of the network, updating a value of a corresponding intersection in the matrix data to a state in which there is no network connection.

### (Supplementary Note 16)

The resource retrieval method according to supplementary note 14 or 15, wherein

the resource condition includes a condition relating to a period, and

the retrieving includes updating the free line information of the network according to the period included in the resource condition.

### (Supplementary Note 17)

A program and a computer-readable medium storing a program for causing a computer to execute the steps of, the computer being connected with a plurality of computer systems each having one or more resources, the resources being a computer resource and a network resource, the computer including network information storage means for storing information relating to a network connecting a first computer system and second computer systems, the first computer system being a particular computer system of the plurality of the computer systems, the second computer systems being computer systems other than the particular computer system:

computing a set of the second computer systems connected with the first computer system over the network, based on the information relating to the network stored in the network information storage means; and

retrieving a resource to be provided for use in the first computer system, from among resources held by the second computer systems included in the computed set.

### (Supplementary Note 18)

The program and the computer-readable medium storing the program, according to supplementary note 17, wherein

the retrieving includes retrieving a resource satisfying a resource condition required by the first computer system as the resource to be provided for use in the first computer system, from among the resources held by the second computer systems included in the set.

### (Supplementary Note 19)

The program and the computer-readable medium storing the program, according to supplementary note 17, wherein

the information relating to the network connecting the first computer system and the second computer systems includes matrix data in which identifiers of the first computer system and the second computer systems take a vertical axis and a horizontal axis, and presence or absence of a network connection is associated at each of intersections of the axes,

the computing includes computing the set based on the matrix data, and

the retrieving includes retrieving a resource satisfying a resource condition required by the first computer system as the resource to be provided for use in the first computer system, from among the resources held by the second computer systems included in the computed set.

### (Supplementary Note 20)

The program and the computer-readable medium storing the program, according to supplementary note 17, wherein

the information relating to the network connecting the first computer system and the second computer systems includes:
matrix data in which identifiers of the first computer system and the second computer systems take a vertical axis and a horizontal axis, and presence or absence of a network connection is associated at each of intersections of the axes; and
free line information, per unit time, of the network connecting the first computer system and the second computer systems,

the computing includes computing the set based on the matrix data, and

the retrieving includes retrieving a resource satisfying a resource condition required by the first computer system as the resource to be provided for use in the first computer system, from among the resources held by the second computer systems which are included in the computed set and in which a free line is present in the network with the first computer system.

### (Supplementary Note 21)

The program and the computer-readable medium storing the program, according to supplementary note 17, wherein

the information relating to the network connecting the first computer system and the second computer systems includes:
matrix data in which identifiers of the first computer system and the second computer systems take a vertical axis and a horizontal axis, and presence or absence of a network connection is associated at each of intersections of the axes;
free line information, per unit time, of the network connecting the first computer system and the second computer systems; and
quality information of the network,

the computing includes computing the set based on the matrix data, and

the retrieving includes retrieving a resource satisfying a resource condition required by the first computer system as the resource to be provided for use in the first computer system, from among the resources held by the second computer systems which are included in the computed set and in which a free line satisfying quality required by the first computer system is present in the network with the first computer system.

### (Supplementary Note 22)

The program and the computer-readable medium storing the program, according to supplementary note 20 or 21, wherein

the retrieving includes, when a resource to be provided for use in the first computer system has been determined, updating the free line information of the network connecting the second computer system having the determined resource and the first computer system, by a quantity to be used by the determined resource.

### (Supplementary Note 23)

The program and the computer-readable medium storing the program, according to supplementary note 22, wherein

the retrieving includes, if there is no free line any more in the network connecting the first computer system and the second computer systems due to updating of the free line information of the network, updating a value of a corresponding intersection in the matrix data to a state in which there is no network connection.

### (Supplementary Note 24)

The program and the computer-readable medium storing the program, according to supplementary note 22 or 23, wherein

the resource condition includes a condition relating to a period, and

the retrieving includes updating the free line information of the network according to the period included in the resource condition.

### DESCRIPTION OF REFERENCE NUMERALS

1 computer system
2 communication channel
3 computer
4 resource
5 computer
6 network information storage section
7 retrieval section

1. A computer connected with a plurality of computer systems each having one or more resources, the resources being a computer resource and a network resource, the computer comprising:
a network information storage unit that stores information relating to a network connecting a first computer system and second computer systems, the first computer system being a particular computer system of the plurality of the computer systems, the second computer systems being computer systems other than the particular computer system; and
a retrieval unit that computes a set of the second computer systems connected with the first computer system over the network based on the information relating to the network stored in the network information storage unit, and retrieves a resource to be provided for use in the first computer system, from among resources held by the second computer systems included in the computed set.

2. The computer according to claim 1, wherein
the retrieval unit retrieves a resource satisfying a resource condition required by the first computer system as the resource to be provided for use in the first computer system, from among the resources held by the second computer systems included in the set.

3. The computer according to claim 1, wherein
the information relating to the network connecting the first computer system and the second computer systems includes matrix data in which identifiers of the first computer system and the second computer systems take a vertical axis and a horizontal axis, and presence or absence of a network connection is associated at each of intersections of the axes, and
the retrieval unit computes the set based on the matrix data, and retrieves a resource satisfying a resource condition required by the first computer system as the resource to be provided for use in the first computer system, from among the resources held by the second computer systems included in the computed set.

4. The computer according to claim 1, wherein
the information relating to the network connecting the first computer system and the second computer systems includes:
matrix data in which identifiers of the first computer system and the second computer systems take a vertical axis and a horizontal axis, and presence or absence of a network connection is associated at each of intersections of the axes; and
free line information, per unit time, of the network connecting the first computer system and the second computer systems, and
the retrieval unit computes the set based on the matrix data, and retrieves a resource satisfying a resource condition required by the first computer system as the resource to be provided for use in the first computer system, from among the resources held by the second computer systems which are included in the computed set and in which a free line is present in the network with the first computer system.

5. The computer according to claim 1, wherein
the information relating to the network connecting the first computer system and the second computer systems includes:
matrix data in which identifiers of the first computer system and the second computer systems take a vertical axis and a horizontal axis, and presence or absence of a network connection is associated at each of intersections of the axes;
free line information, per unit time, of the network connecting the first computer system and the second computer systems; and
quality information of the network, and
the retrieval unit computes the set based on the matrix data, and retrieves a resource satisfying a resource condition required by the first computer system as the resource to be provided for use in the first computer system, from among the resources held by the second computer systems which are included in the computed set and in which a free line satisfying quality required by the first computer system is present in the network with the first computer system.

6. The computer according to claim 4, wherein
when the retrieval unit has determined a resource to be provided for use in the first computer system, the retrieval unit updates the free line information of the network connecting the second computer system having the determined resource and the first computer system, by a quantity to be used by the determined resource.

7. The computer according to claim 6, wherein
if there is no free line any more in the network connecting the first computer system and the second computer systems due to updating of the free line information of the network, the retrieval unit updates a value of a corresponding intersection in the matrix data to a state in which there is no network connection.

8. The computer according to claim 6, wherein
the resource condition includes a condition relating to a period, and
the retrieval unit updates the free line information of the network according to the period included in the resource condition.

9. A resource retrieval method to be executed by a computer connected with a plurality of computer systems each having one or more resources, the resources being a computer resource and a network resource, the computer including a network information storage unit that stores information relating to a network connecting a first computer system and second computer systems, the first computer system being a particular computer system of the plurality of the computer systems, the second computer systems being computer systems other than the particular computer system, the method comprising:
computing a set of the second computer systems connected with the first computer system over the network based on the information relating to the network stored in the network information storage unit; and
retrieving a resource to be provided for use in the first computer system, from among resources held by the second computer systems included in the computed set.

10. The resource retrieval method according to claim 9, wherein
the retrieving includes retrieving a resource satisfying a resource condition required by the first computer system as the resource to be provided for use in the first computer system, from among the resources held by the second computer systems included in the set.

11. The resource retrieval method according to claim 9, wherein
the information relating to the network connecting the first computer system and the second computer systems includes matrix data in which identifiers of the first computer system and the second computer systems take a vertical axis and a horizontal axis, and presence or absence of a network connection is associated at each of intersections of the axes,
the computing includes computing the set based on the matrix data, and
the retrieving includes retrieving a resource satisfying a resource condition required by the first computer system as the resource to be provided for use in the first computer system, from among the resources held by the second computer systems included in the computed set.

12. The resource retrieval method according to claim 9, wherein
the information relating to the network connecting the first computer system and the second computer systems includes:
matrix data in which identifiers of the first computer system and the second computer systems take a vertical axis and a horizontal axis, and presence or absence of a network connection is associated at each of intersections of the axes; and
free line information, per unit time, of the network connecting the first computer system and the second computer systems,
the computing includes computing the set based on the matrix data, and
the retrieving includes retrieving a resource satisfying a resource condition required by the first computer system as the resource to be provided for use in the first computer system, from among the resources held by the second computer systems which are included in the computed set and in which a free line is present in the network with the first computer system.

13. The resource retrieval method according to claim 9, wherein
the information relating to the network connecting the first computer system and the second computer systems includes:
matrix data in which identifiers of the first computer system and the second computer systems take a vertical axis and a horizontal axis, and presence or absence of a network connection is associated at each of intersections of the axes;
free line information, per unit time, of the network connecting the first computer system and the second computer systems; and
quality information of the network,
the computing includes computing the set based on the matrix data, and
the retrieving includes retrieving a resource satisfying a resource condition required by the first computer system as the resource to be provided for use in the first computer system, from among the resources held by the second computer systems which are included in the computed set and in which a free line satisfying quality required by the first computer system is present in the network with the first computer system.

14. The resource retrieval method according to claim 12, wherein
the retrieving includes, when a resource to be provided for use in the first computer system has been determined, updating the free line information of the network connecting the second computer system having the determined resource and the first computer system, by a quantity to be used by the determined resource.

15. The resource retrieval method according to claim 14, wherein
the retrieving includes, if there is no free line any more in the network connecting the first computer system and the second computer systems due to updating of the free line information of the network, updating a value of a corresponding intersection in the matrix data to a state in which there is no network connection.

16. The resource retrieval method according to claim 14, wherein
the resource condition includes a condition relating to a period, and
the retrieving includes updating the free line information of the network according to the period included in the resource condition.

17. A non-transitory computer-readable medium having instructions to cause a computer to execute a method for controlling the computer, the computer being connected with a plurality of computer systems each having one or more resources, the resources being a computer resource and a network resource, the computer including a network information storage unit that stores information relating to a network connecting a first computer system and second computer systems, the first computer system being a particular computer system of the plurality of the computer systems, the second computer systems being computer systems other than the particular computer system, the method comprising the steps of:
computing a set of the second computer systems connected with the first computer system over the network based on the information relating to the network stored in the network information storage unit; and
retrieving a resource to be provided for use in the first computer system, from among resources held by the second computer systems included in the computed set.
